(19) United States
(12) Patent Application Publication
(10) Pub. No.: US 2026/0246392 A1
(43) Pub. Date: Aug. 20, 2026

(54) CONTROL CHIP AND SWITCHING POWER SUPPLY

(71) Applicant: FUJI ELECTRIC CO., LTD., Kanagawa (JP)

(72) Inventor: Shinji MATSUMOTO, Matsumoto-city (JP)

(21) Appl. No.: 19/457,158

(22) Filed: Jan. 23, 2026

(30) Foreign Application Priority Data
Feb. 20, 2025 (JP) 2025-025762

(51) Int. Cl. H02M 3/335

(52) U.S. Cl. CPC H02M 3/33576

(57) ABSTRACT

Provided is a control chip that is supplied with input power from a power supply circuit, and controls a switching device of a switching power supply which supplies output power to a load, including: at least two operating modes, including a power supply test mode for testing the power supply circuit and a normal operating mode; a feedback terminal to which a feedback signal is input according to an output voltage applied to the load; and a power supply test mode switching unit that switches between the power supply test mode and the normal operating mode according to a switch signal input to the feedback terminal.

The contents of the following patent application (s) are incorporated herein by reference:

NO. 2025-025762 filed in JP on February 20, 2025.

### BACKGROUND

### 1. Technical Field

The present invention relates to a control chip and a switching power supply.

### 2. Related Art

In Patent document 1, it is described that a power supply control IC has a “test mode different from a normal operating mode” (paragraph 0002), and performs “an IC test” in the test mode (paragraph 0007). In Patent document 2, “a method that uses a sped-up clock instead of the actual device clock to shorten test time” (paragraph 0002) is described. In Patent document 3, it is described that “when a setting circuit generates a test mode setting output, the output clock of the clock generation circuit is output to the internal circuit instead of the external input clock” (claim 1).

Patent Document 1: Japanese Patent Application Publication No. 2007-258294

Patent Document 2: Japanese Patent Application Publication No. H5-11025

Patent Document 3: Japanese Patent Application Publication No. H3-204951.

### BRIEF DESCRIPTION OF THE DRAWINGS

FIG. 1 illustrates an example of a switching power supply 300.

FIG. 2 illustrates a configuration example of a control chip 100.

FIG. 3 illustrates an example of time waveforms of each voltage and a clock signal in a normal operating mode.

FIG. 4 illustrates an example of time waveforms of each voltage and a clock signal when transitioning to a power supply test mode.

FIG. 5 illustrates an example of time waveforms of each voltage and a clock signal when transitioning to a circuit test mode.

FIG. 6 illustrates an exemplary operation during an initial setting period.

FIG. 7 illustrates a schematic view of the normal operating mode, the circuit test mode and the power supply test mode.

FIG. 8 illustrates a configuration example of a power supply test mode switching unit 34 and a time reduction unit 46.

FIG. 9 illustrates a configuration example of a clock generation unit 60.

### DESCRIPTION OF EXEMPLARY EMBODIMENTS

Hereinafter, the present invention will be described through embodiments of the invention, but the following embodiments do not limit the invention according to the claims. In addition, not all of the combinations of features described in the embodiments are essential to the solving means of the invention. Note that in the present specification and the diagrams, elements having substantially the same function and architecture are denoted with a same reference sign to omit duplicated descriptions, and illustrations of elements that are not directly related to the present invention will be omitted. Further, in one diagram, elements having the same functions and architecture are denoted by a representative reference sign, and other reference signs for the elements may be omitted. In the present specification, a case where a term such as "same" or "equal" is mentioned may include a case having an error due to a variation in manufacturing or the like. The error is, for example, within 10%.

In an explanation of a circuit, when it is described that an element C is provided "between" an element A and an element B, it implies that the element C is provided between the element A and the element B in an electrical channel. The above explanation is not for limiting a spatial position of the element C.

When it is described in the present specification that two elements are "electrically connected", it refers to a state in which an electric signal, a voltage, or a current can be transmitted between the two elements. The two elements may be directly connected by a wiring or the like, or another electrical element may be present between the two elements.

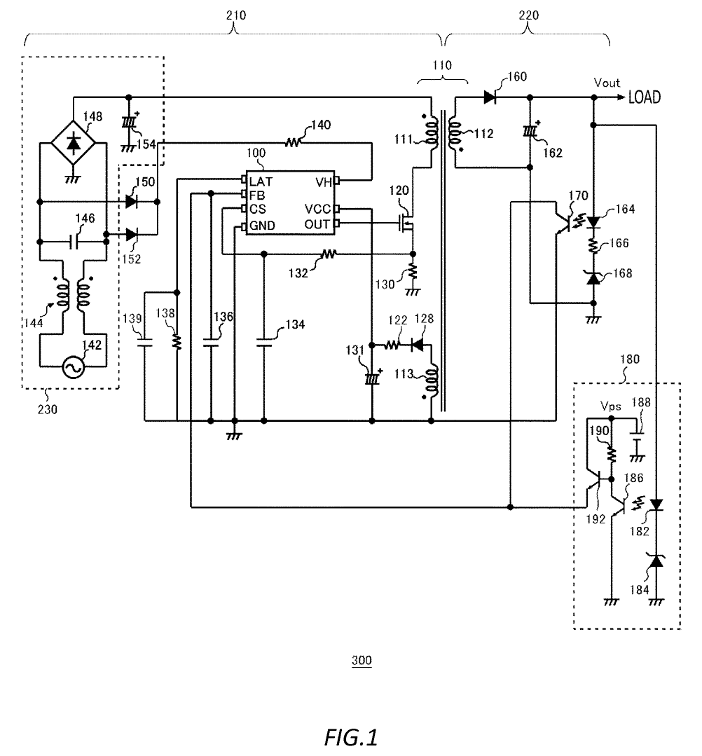

FIG. 1 illustrates an example of a switching power supply 300. The switching power supply 300 is supplied with input power from a power supply circuit 230 and supplies output power to a load. By repeatedly controlling a switching device 120 connected to a primary-side winding 111 of a main transformer 110 to be put into an ON state and an OFF state, the switching power supply 300 generates a predetermined voltage or current in a secondary-side winding 112 of the main transformer. In the present example, the switching power supply 300 includes a power supply circuit 230, a primary-side circuit 210, a secondary-side circuit 220, a switching signal generation unit 180 and a main transformer 110.

The primary-side circuit 210 may include a power supply circuit 230. The power supply circuit 230 supplies power supply electric power to the primary-side circuit 210. In the present example, the power supply circuit 230 has an AC power supply 142, a coil 144, a smoothing capacitor 146, a diode bridge unit 148, a diode 150, a diode 152 and a capacitor 154. The AC power supply 142 may be an external power supply such as a commercial power supply.

The coil 144 is connected to the AC power supply 142. The coil 144 may be provided for both a positive-side output terminal and a negative-side output terminal of the AC power supply 142. The coil 144 may be a transformer connected to the positive-side output terminal and the negative-side output terminal of the AC power supply 142. The smoothing capacitor 146 is provided between a positive-side output terminal and a negative-side output terminal of the AC power supply 142. The noise in the AC power output by the AC power supply 142 is removed by the coil 144 and the smoothing capacitor 146.

The diode bridge unit 148 performs full-wave rectification of the AC power output by the AC power supply 142. The capacitor 154 smoothens electrical power rectified by the diode bridge unit 148. With this configuration, the power supply circuit 230 rectifies and smoothens the voltage and current from the AC power supply 142 to be output.

In the present example, the primary-side circuit 210 has a control chip 100, a primary-side winding 111, a switching device 120, a resistor 130, a auxiliary winding 113, a diode 128, a resistance element 122, a capacitor 131, a capacitor 134, a capacitor 136, a resistor 132, a resistor 138, a capacitor 139 and a resistor 140. The primary-side winding 111 of the present example is supplied with the power supply electric power from the power supply circuit 230.

The secondary-side circuit 220 of the present example includes the secondary-side winding 112, a diode 160, a capacitor 162, a light emitter 164, a resistor 166, and a diode 168. The secondary-side winding 112 is magnetically coupled to the primary-side winding 111. Note that a light receiving element 170 illustrated in FIG. 1 may be provided in the primary-side circuit 210.

The switching device 120 performs switching control of a main current flowing through the main transformer 110. The switching device 120 of the present example is connected to the primary-side winding 111 in series and performs switching control as to whether or not the main current is caused to flow through the primary-side winding 111. The switching device 120 is a power MOSFET, for example. The resistor 130 is provided between the switching device 120 and a reference potential. The resistor 130 is a resistor for detecting a magnitude of the main current.

The control chip 100 controls ON and OFF states of the switching device 120. The control chip 100 may output a control signal input to the gate terminal of the switching device 120. The control chip 100 is a semiconductor integrated circuit chip, for example. In the present example, the control chip 100 has a LAT terminal, a FB terminal (feedback terminal), a CS terminal, a GND terminal, a VH terminal (power supply detection terminal), a VCC terminal (power supply terminal) and an OUT terminal.

When the switching device 120 is put into the ON state and an excitation current flows through the primary-side winding 111, a load current according to a turn ratio flows through the secondary-side winding 112. The load current flowing through the secondary-side winding 112 is rectified by the diode 160. The capacitor 162 is charged with an output of the diode 160. The load is applied with an output voltage Vout according to an amount of charges accumulated in the capacitor 162.

The auxiliary winding 113 supplies power supply electric power to the VCC terminal. The VCC terminal is a power supply terminal with a power voltage for driving the control chip 100 applied thereon. In the present example, the auxiliary winding 113 is arranged between the VCC terminal and the reference potential of the control chip 100. The auxiliary winding 113 is magnetically coupled to the secondary-side winding 112. That is, a current according to the current of the secondary-side winding 112 flows through the auxiliary winding 113. A resistance element 122 and a diode 128 may be arranged between the auxiliary winding 113 and the VCC terminal. The diode 128 rectifies the current flowing through the auxiliary winding 113. The resistance element 122 is arranged between the diode 128 and the VCC terminal. The capacitor 131 is charged by a current passing through the diode 128.

The capacitor 131 is electrically connected to the VCC terminal of the control chip 100. The electrical power accumulated in the capacitor 131 is supplied as power supply electric power of the control chip 100. The capacitor 131 in the present example is an electrolytic capacitor. The capacity of the capacitor 131 may be greater than the capacity of the capacitor 134 or the capacitor 136.

The control chip 100 may include a CS terminal which senses a magnitude of the main current (drain current in the present example) flowing through the switching device 120. The CS terminal takes in a potential representing a magnitude of a voltage drop in the resistor 130. Since the voltage drop according to the magnitude of the main current occurs in the resistor 130, the magnitude of the main current can be sensed from the potential. The CS terminal of the present example takes in a potential at an end of the resistor 130 connected to the switching device 120. A filter constituted by the resistor 132 and the capacitor 134 may be provided between the CS terminal and the resistor 130. The control chip 100 may control the switching device 120 to be put into the OFF state when an overcurrent flows through the switching device 120.

A feedback signal according to the output voltage Vout applied to the load is input from the secondary-side circuit 220 to the FB terminal. The light emitter 164, the resistor 166, and the diode 168 in the secondary-side circuit 220 are provided in series between a terminal from which the output voltage Vout is output and the reference potential. A current according to the magnitude of the output voltage Vout flows through the light emitter 164 to output light with an intensity according to the magnitude of the current. The light emitter 164 is a light emitting diode, for example.

The light receiving element 170 receives light output by the light emitter 164. The light receiving element 170 is a phototransistor, for example. The light receiving element 170 inputs a current according to an intensity of the received light to the FB terminal. In this manner, the current according to the output voltage Vout flows through the FB terminal. In this manner, a voltage according to the output voltage Vout is generated at the FB terminal, and becomes an output voltage detection signal (feedback signal). The current flowing to the FB terminal has the amount of currents increased as the output voltage Vout becomes greater, and has the amount of currents decreased as the output voltage Vout beceoms lower. The primary-side circuit 210 may include the capacitor 136 provided in parallel with the light receiving element 170. This can remove a high-frequency component of the current flowing through the FB terminal.

A voltage of the FB terminal varies according to the output voltage Vout. The control chip 100 controls a period in which the switching device 120 is turned on and a period in which the switching device 120 is turned off according to the voltage of the FB terminal. As an example, in the control chip 100, as the output voltage Vout becomes greater than the target voltage, the period during which the switching device 120 is on in each switching cycle becomes shorter.

In the present example, the VH terminal is connected to the power supply circuit 230 via the diode 150, the diode 152 and the resistor 140. At start-up of the switching power supply 300, the VH terminal supplies a charge current to the VCC terminal based on the electrical power from the power supply circuit 230. In this manner, the capacitor 131 connected to the VCC terminal is charged. As the voltage of the capacitor 131 increases and the switching control by the control chip 100 starts, the supply of the charge current from the VH terminal stops. With this configuration, while the activation of the control chip 100 can be sped up, it is possible to reduce power consumption.

In the present example, the LAT terminal is used to perform an initial setting of the control chip 100. The features or the like of the control chip 100 is set by adjusting the voltage of the LAT terminal during the initial setting period of the control chip 100. The features of the control chip 100 refer to, for example, an X-CAP discharge feature and a frequency spreading feature. Details about these features are described below. In the present example, the control chip 100 can make these features valid or invalid by adjusting the voltage of the LAT terminal into a predetermined range at a predetermined timing of the initial setting period.

In the present example, a resistor 138 and a capacitor 139 are connected in parallel to each other between the LAT terminal and the reference potential. During the initial setting period, the control chip 100 outputs a constant current from the LAT terminal. Therefore, the voltage waveform at the LAT terminal is determined by the resistance value of the resistor 138 and the capacity of the capacitor 139. The voltage waveform of the LAT terminal can be adjusted and the initial setting of the control chip 100 can be performed by adjusting the resistance value of the resistor 138 and the capacity of the capacitor 139. During the initial setting period, the resistance value of the resistor 138 and the capacity of the capacitor 139 may be variable.

In the present example, the control chip 100 has at least two operating modes including a power supply test mode for testing the power supply circuit 230 and a normal operating mode. In the normal operating mode, the control chip 100 supplies output power to the load based on the input power from the power supply circuit 230. The power supply test mode may be a test of the switching power supply 300 performed by a user of the switching power supply 300, for example.

In the power supply test mode, some parameters inside the control chip 100 are set in different states from the normal operating mode. In the present example, the control chip 100 reduces the overload protection detection delay time compared to the normal operating mode in the power supply test mode.

The overload protection detection delay time is time from overload being detected until the start of the protective operations. For example, the control chip 100 may be determined to be in an overload state when the output power to the load exceeds a threshold. The control chip 100 performs protective operations when the overload state has continued for the overload protection detection delay time. For example, the protective operations may be operations that stop the switching operation of the switching device 120 to fix the switching device 120 in the OFF state. By providing the overload protection detection delay time, it can be suppressed to stop the switching device 120 by mis-detection of the overload state due to noise or the like. For example, the overload protection detection delay time may be set to be approximately several seconds.

The switching power supply 300 may be in the overload state to be tested although in the power supply test mode. However, leaving the overload protection detection delay time unchanged will cause the test to take too long time. As described above, the test of the power supply circuit 230 can be performed efficiently by reducing the overload protection detection delay time in the power supply test mode. For example, in the power supply test mode, the overload protection detection delay time may be changed to be half or less, or 1/4 or less, or 1/10 or less compared to the normal operating mode.

On the other hand, in the power supply test mode, the control chip 100 is preferably activated in a state close to the normal operating mode. In this manner, the power supply circuit 230 and the control chip 100 can be tested in an environment close to the normal operating mode. For example, among the settable parameters in the control chip 100, the parameters other than the duration of the overload protection detection delay time may be unchanged between the power supply test mode and the normal operating mode.

For example, the settings of the delay period other than the overload protection detection delay time may be unchanged between the power supply test mode and the normal operating mode. Also, in the power supply test mode, the control chip 100 may not reduce the initial setting period when compared to the normal operating mode. Details about the initial setting period are described below. Also, the setting to enable or disable the features of the control chip 100, such as the X-CAP discharge feature and the frequency spreading feature, may not be changed between the power supply test mode and the normal operating mode.

The control chip 100 may further have a circuit test mode for testing the control chip 100 as one operating mode. In the circuit test mode, in as state where the AC power supply 142 or the power supply circuit 230 is not connected, the control chip 100 may be tested. The control chip 100 operates in the power supply test mode closer to the normal operating mode than the circuit test mode. For example, the control chip 100 reduces the overload protection detection delay time and reduces the initial setting period when compared to the normal operating mode in the circuit test mode.

For example, the settings of the delay period other than the overload protection detection delay time may be reduced to be shorter than the normal operating mode in the circuit test mode. In this manner, the operation test of the control chip 100 can be performed in a short time. Also, in the circuit test mode, the X-CAP discharge feature and the frequency spreading feature may be set to be invalid. In this manner, the operation test of the control chip 100 other than the feature can be performed in a short time.

The control chip 100 may switch between the power supply test mode and the normal operating mode according to the switch signal input to the FB terminal. The switch signal is a signal different from the feedback signal according to the output voltage Vout. That is, both the feedback signals according to the switch signal and the output voltage Vout are input to the FB terminal. It is possible to switch to the operating mode without increasing the number of terminals of the control chip 100 by switching the operating mode using the FB terminal.

In the present example, the switch signal is generated by the switching signal generation unit 180. The switching signal generation unit 180 inputs a switch signal of a predetermined voltage to the FB terminal when the output voltage Vout is lower than a predetermined threshold voltage. Also, the switching signal generation unit 180 stops inputting the switch signal to the FB terminal when the output voltage Vout is equal to or greater than the threshold voltage. When the input of the switch signal is stopped, a feedback signal indicating the magnitude of the output voltage Vout is input to the FB terminal. In the present example, the switch signal is input to the FB terminal in a state where the output voltage Vout is low at start-up of the switching power supply 300 or the like.

In the present example, the switching signal generation unit 180 has a light emitter 182, a diode 184, a light receiving element 186, a power supply 188, a resistor 190 and a transistor 192. The light emitter 182 and the diode 184 are provided in series between a terminal that outputs an output voltage Vout and the reference potential. A current according to the magnitude of the output voltage Vout flows through the light emitter 182 to output light with an intensity according to the magnitude of the current. The light emitter 182 is a light-emitting diode, for example.

The light receiving element 186 receives light output by the light emitter 182. The light receiving element 186 is a phototransistor, for example. The light receiving element 186 drives a current according to the intensity of received light to flow through a resistor 190. The resistor 190 is provided between the power supply 188 and the light receiving element 186. According to the current flowing through the resistor 190, a voltage of the connection node between the resistor 190 and the light receiving element 186 is determined.

In the transistor 192, a control terminal such as a base terminal or a gate terminal is connected to the connection node. The transistor 192 switches the power supply 188 to connect or disconnect to the FB terminal. When the output voltage Vout is lower than a threshold voltage and the current flowing through the resistor 190 is low, since the voltage drop at the resistor 190 is low, the voltage at the connection node remains high. In this case, in the present example, the transistor 192 becomes in an ON state, and a voltage Vps of the power supply 188 is input to the FB terminal as a switch signal. When the output voltage Vout is equal to or greater than the threshold voltage, and the current flowing through the resistor 190 increases, the voltage drop at the resistor 190 increases. In this case, in the present example, the transistor 192 becomes in an OFF state, and the power supply 188 is disconnected from the FB terminal. As a result, a voltage according to the output voltage Vout is input to the FB terminal.

When performing the test os the power supply circuit 230, the power supply 188 may be prepared by the user of the switching power supply 300. The user may connect the power supply 188 to the switching power supply 300 to generate a switch signal when performing the test of the power supply circuit 230. A configuration of the switching signal generation unit 180 other than the power supply 188 may be pre-incorporated into the switching power supply 300, or the user may prepare it.

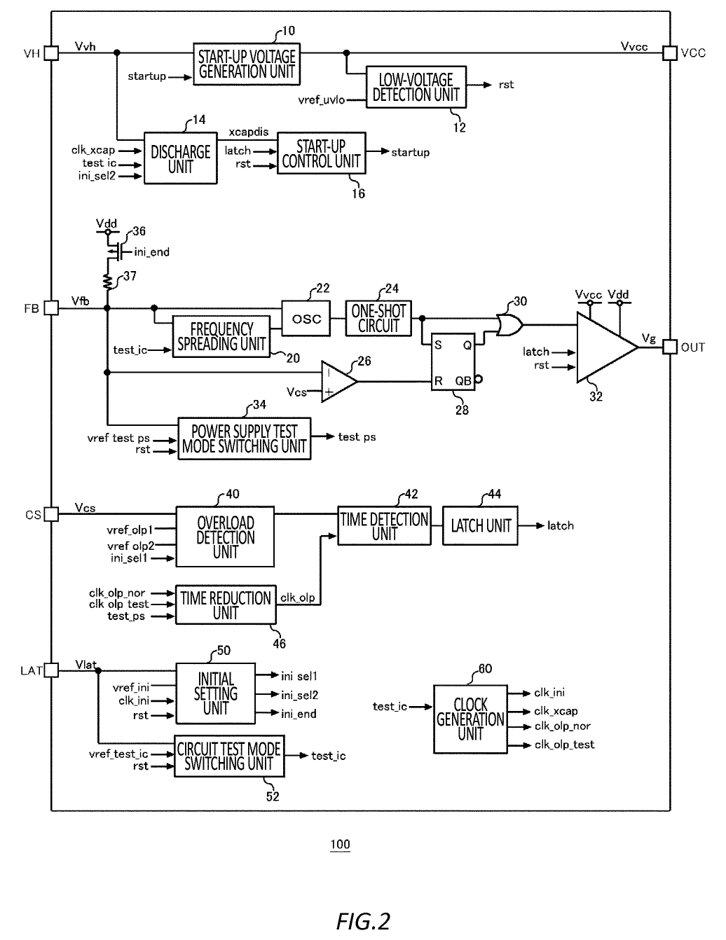

FIG. 2 illustrates a configuration example of the control chip 100. The configuration of each terminal of the control chip 100 is similar to that shown in the example of FIG. 1. However, in FIG. 2, the GND terminal is omitted. The reference potential applied to the GND terminal may be used as reference potential of an internal circuit of the control chip 100.

In the present example, the control chip 100 includes a start-up voltage generation unit 10, a low-voltage detection unit 12, a discharge unit 14 and a start-up control unit 16. These configurations are directly or indirectly connected to the VH terminal or the VCC terminal.

The start-up voltage generation unit 10 charges the capacitor 131 (see FIG. 1) based on the voltage Vvh of the VH terminal at start-up of the switching power supply 300. The start-up voltage generation unit 10 may charge the capacitor 131 according to the start-up signal startup. In this manner, at start-up of the switching power supply 300, during a period when the current flowing through the auxiliary winding 113 is low, the power voltage Vvcc of the control chip 100 can be increased.

The low-voltage detection unit 12 detects whether or not the power voltage Vvcc has become equal to or greater than a predetermined release voltage vref_uvlo. The low-voltage detection unit 12 stops operations of at least a part of the circuit of the control chip 100, or outputs a reset signal rst to reset to an initial state, when the power voltage Vvcc is lower than the release voltage vref_uvlo. For example, the low-voltage detection unit 12 stops switching operation in the switching device 120 when the power voltage Vvcc is lower than a release voltage vref_uvlo that has been set.

The start-up control unit 16 outputs the start-up signal startup according to the reset signal rst. The start-up control unit 16 may output the start-up signal startup when the power voltage Vvcc is lower than the release voltage vref_uvlo. In this manner, when the power voltage Vvcc is lower than the release voltage vref_uvlo, the start-up voltage generation unit 10 generates the power voltage Vvcc, and when the power voltage Vvcc is equal to or greater than the release voltage vref_uvlo, the power voltage Vvcc can be generated by the current flowing through the auxiliary winding 113. The start-up control unit 16 may generate the start-up signal startup also by a latch signal latch and a discharge signal xcapdis described below.

When the voltage Vvh input to the VH terminal is a DC voltage, the discharge unit 14 discharges the smoothing capacitor 146 (see FIG. 1) (X-CAP discharge feature). When a state where the variation (amplitude) of the voltage Vvh remains equal to or lower than a reference value persisted for a reference period time or longer, the discharge unit 14 may determine the voltage Vvh to be a DC voltage.

If the AC power supply 142 transitions from a connected state to a disconnected state, the smoothing capacitor 146 retains the electric charge charged by the AC power supply 142. If the electric charge remains in the smoothing capacitor 146, there occurs a risk of electric shock or the like. Therefore, when the voltage Vvh has become a DC voltage, it is preferable to discharge the smoothing capacitor 146.

The discharge unit 14 may discharge the smoothing capacitor 146 by extracting the electric charge via the diode 150 and the diode 152. In this manner, the discharge resistance for discharging the smoothing capacitor 146 may not be provided in parallel with the smoothing capacitor 146. Therefore, losses due to discharge resistance in the normal operating mode or the like can be eliminated.

The discharge unit 14 may input the discharge signal xcapdis to the start-up control unit 16 when discharging the smoothing capacitor 146. The start-up control unit 16 outputs the start-up signal startup when the smoothing capacitor 146 has been discharged. In this manner, the power voltage Vvcc is generated by the start-up voltage generation unit 10.

In the present example, the operations of the discharge unit 14 may be stopped by a circuit test mode signal test_ic indicating that the control chip 100 is in a circuit test mode. In this manner, in the circuit test mode, the X-CAP discharge feature can be invalid. In the normal operating mode and the power supply test mode, the X-CAP discharge feature may be valid.

In the circuit test mode, a voltage is input to the VH terminal of the control chip 100 from a testing apparatus or the like. Even if the testing apparatus can not apply an AC voltage to the VH terminal, the test of the control chip 100 can be performed by disabling the X-CAP discharge feature. On the other hand, by enabling the X-CAP discharge feature in the power supply test mode, the power supply circuit 230 can be tested in an environment close to the normal operating mode.

The discharge unit 14 may operate according to the operation clock clk_xcap. The operation clock clk_xcap is generated by a clock generation unit 60 described below. A period of the operation clock clk_xcap may be constant in either of the normal operating mode or the power supply test mode. The period of the operation clock clk_xcap in the circuit test mode may be shorter than the period of the operation clock clk_xcap in another operating mode.

The discharge unit 14 may have the X-CAP discharge feature to be set as valid and invalid according to the initial setting signal ini_sel 2. The initial setting signal ini_sel 2 is generated by the initial setting unit 50.

In the present example, the control chip 100 includes an initial setting unit 50 and a circuit test mode switching unit 52. These configurations are connected directly or indirectly to the LAT terminal.

The initial setting unit 50 sets each parameter of the control chip 100 according to the voltage Vlat at the LAT terminal. The user can adjust the voltage Vlat by the resistor 138 and the capacitor 139 (see FIG. 1) to set each parameter of the control chip 100.

In the present example, the voltage Vlat, a reference voltage vref_ini, an operation clock clk_ini and the reset signal rst are input to the initial setting unit 50. A voltage value of the reference voltage vref_ini is preset. The control chip 100 may have a voltage generation circuit that generates the reference voltage vref_ini. The initial setting unit 50 generates one or more initial setting signals ini_sel 1, ini_sel2, ini_end based on the comparison result of the voltage Vlat and the reference voltage vref_ini.

As described above, the initial setting signal ini_sel 2 is a signal that disables the X-CAP discharge feature. That is, the X-CAP discharge feature can be disabled by the settings of a user. The initial setting signal ini_sel 1 is a signal that sets the magnitude of a reference value for determining whether or not an overload state exists in an overload detection unit 40 described below. The initial setting signal ini_end is a signal indicating whether or not the initial setting period has ended. The initial setting unit 50 may output the initial setting signal ini_end when a preset period has elapsed after the reset signal rst is released. The period may be measured by counting pulses of the operation clock clk_ini.

The circuit test mode switching unit 52 outputs the circuit test mode signal test_ic that transitions to the circuit test mode based on the voltage Vlat of the LAT terminal. In the present example, the voltage Vlat, a reference voltage vref_test_ic and the reset signal rst are input to the circuit test mode switching unit 52.

In the present example, the circuit test mode switching unit 52 generates the circuit test mode signal test_ic based on the comparison result of the voltage Vlat and the reference voltage vref_test_ic. For example, the circuit test mode switching unit 52 generates the circuit test mode signal test_ic when the voltage Vlat when the reset signal rst has been released (that is, when the power voltage Vvcc has become equal to or greater than the release voltage vref_uvlo) is equal to or greater than the reference voltage vref_test_ic. By such operations, the control chip 100 can transition to the circuit test mode.

In the present example, the control chip 100 includes a transistor 36, a resistor 37, a frequency spreading unit 20, an oscillator circuit 22, an one-shot circuit 24, a comparator circuit 26, a flip-flop 28, a logical disjunction circuit 30, a driver circuit 32 and a power supply test mode switching unit 34. These configurations are connected directly or indirectly to the FB terminal or the OUT terminal.

The transistor 36 switches to connect or disconnect the voltage line Vdd to the FB terminal according to the initial setting signal ini_end. The voltage of the voltage line Vdd may be generated inside the control chip 100. The resistor 37 is connected in series between the transistor 36 and the FB terminal. In the present example, the transistor 36 connects the voltage line Vdd to the FB terminal when the initial setting period has ended. In this case, the voltage Vfb of the FB terminal is determined by the current that is caused to flow by the light receiving element 170 according to the output voltage Vout. In this manner, after the initial setting period ends, the control chip 100 operates according to the output voltage Vout.

The transistor 36 disconnects the voltage line Vdd from the FB terminal before the initial setting period ends. In this case, the switch signal generated by the switching signal generation unit 180 is input to the FB terminal as the voltage Vfb.

The oscillator circuit 22 generates an oscillation signal with a period corresponding to voltage Vfb. The oscillator circuit 22 may have a voltage control oscillator (VCO).

The one-shot circuit 24 outputs pulses of a predetermined width according to the period of the oscillation signal from the oscillator circuit 22. For example, the one-shot circuit 24 outputs the pulse at each rising edge of the oscillation signal.

The comparator circuit 26 outputs the comparison result of the voltage Vfb and the voltage Vcs of the CS terminal. In the present example, the comparator circuit 26 outputs a logic L when the voltage Vfb is lower than the voltage Vcs, and outputs a logic H when the voltage Vfb is greater than the voltage Vcs.

In the flip-flop 28, the pulse of the one-shot circuit 24 is input to a set terminal, and the output of the comparator circuit 26 is input to a reset terminal. In the present example, the flip-flop 28 outputs the logic H, from the pulse of the one-shot circuit 24 being input until the voltage Vfb becomes higher than the voltage Vcs.

The logical disjunction circuit 30 outputs a logical disjunction of the pulse output by the one-shot circuit 24 and the pulse output by the flip-flop 28. The driver circuit 32 outputs the control voltage Vg according to the output of the logical disjunction circuit 30 to the OUT terminal. The switching device 120 is controlled by the control voltage Vg. The driver circuit 32 may control the switching device 120 to the ON state according to the pulse of the one-shot circuit 24, and may control the switching device 120 to the OFF state when the voltage Vfb has become greater than the voltage Vcs.

The latch signal latch and the reset signal rst may be input to the driver circuit 32. When at least one of the reset signal rst, or the latch signal, latch, is input, the driver circuit 32 may output a control voltage Vg of an L level to control the switching device 120 to the OFF state.

The frequency spreading unit 20 varies the switching frequency of the switching device 120. For example, the frequency spreading unit 20 periodically varies the switching frequency of the switching device 120. The variation range of the switching frequency is, for example, within 10%, but is not limited thereto. The frequency spreading unit 20 may vary the switching frequency by superimposing periodic jitter to the control signal that controls the switching device 120. The control signal may be an oscillation signal output by the oscillator circuit 22, or may be a pulse output by the one-shot circuit 24, or may be a control voltage Vg output by the driver circuit 32. In the present example, the frequency spreading unit 20 superimposes jitter to the oscillation signal. Frequency spreading unit 20 may superimpose jitter to the oscillation signal by periodically varying the oscillation frequency of the oscillator circuit 22. By varying the switching frequency, the energy of switching noise can be dispersed along the frequency axis. Therefore, the conducted EMI can be reduced.

In the circuit test mode, the frequency spreading unit 20 may be stopped, and in the normal operating mode and the power supply test mode, the frequency spreading unit 20 may be activated. In the present example, the circuit test mode signal test_ic is input to the frequency spreading unit 20. The frequency spreading unit 20 may distinguish whether or not to superimpose jitter to the oscillation signal according to the circuit test mode signal test_ic.

By disabling the frequency spreading feature in the circuit test mode, the switching frequency generated by the control chip 100 can be measured with high precision. On the other hand, by enabling the frequency spreading feature in the power supply test mode, the power supply circuit 230 and the control chip 100 can be tested in an environment close to the normal operating mode.

The power supply test mode switching unit 34 switches between the power supply test mode and the normal operating mode according to the switch signal input to the FB terminal (the voltage Vfb in the present example). In the present example, the voltage Vfb, the reference voltage vref_test_ps and the reset signal rst are input to the power supply test mode switching unit 34.

The power supply test mode switching unit 34 may switch the operating mode according to the comparison result of the voltage Vfb and the reference voltage vref_test_ps. In the present example, the power supply test mode switching unit 34 outputs a power supply test signal, test_ps, that causes the transition to the power supply test mode in a condition where the voltage Vfb is greater than the reference voltage vref_test_ps. The power supply 188 shown in FIG. 1 outputs a voltage Vps greater than the reference voltage vref_test_ps. Accordingly, the power supply test mode switching unit 34 outputs the power supply test signal test_ps in a condition where the voltage Vps is input as the voltage Vfb.

The power supply test mode switching unit 34 may switch between the power supply test mode and the normal operating mode according to the power voltage Vvcc applied to the VCC terminal and the switch signal (or the voltage Vfb). For example, in a state where the power voltage Vvcc is lower than the release voltage vref_uvlo, the power supply test mode switching unit 34 causes the control chip 100 to activate in the power supply test mode when the switch signal (the voltage Vps of the power supply 188) is input as the voltage Vfb. In the present example, the power supply test mode switching unit 34 activates the control chip 100 in the power supply test mode when the switch signal is input before the input of the reset signal rst. When the voltage Vfb (for example, voltage Vps) is greater than the reference voltage vref_test_ps at the point in time when the reset signal rst is input, the power supply test mode switching unit 34 may output the power supply test signal test_ps.

In the present example, the control chip 100 includes an overload detection unit 40, a time detection unit 42, a latch unit 44, and a time reduction unit 46. These configurations are connected directly or indirectly to the CS terminal.

The overload detection unit 40 detects an overload state by comparing the voltage Vcs of the CS terminal to the set reference value vref_olp. The overload detection unit 40 may determine the overload state when the voltage Vcs is greater than the reference value vref_olp. In the present example, the voltage Vcs, a first reference value vref_olp 1, a second reference value vref_olp 2 and the initial setting signal ini_sel 1 are input to the overload detection unit 40. The first reference value vref_olp 1 may be greater or less than the second reference value vref_olp 2. The overload detection unit 40 selects, based on the initial setting signal ini_sel 1, either of the first reference value vref_olp 1 or the second reference value vref_olp 2 to compare with the voltage Vcs. That is, the reference value vref_olp for determining the overload state is selectable among the settings during the initial setting period.

The time detection unit 42 detects whether or not the period during which the overload detection unit 40 determines the overload state exceeds the overload protection detection delay time. The time detection unit 42 may sense that the overload protection detection delay time has elapsed based on the input clock signal clk_olp. In the present example, the time detection unit 42 determines that the period of the overload state has exceeded the overload protection detection delay time when the pulse number of the clock signal clk_olp during the period during which the overload state persists has exceeded a preset value.

The latch unit 44 outputs the latch signal latch when the period of the overload state has exceeded the overload protection detection delay time. The latch unit 44 may continue to output the latch signal latch until the overload state is resolved. The latch signal latch is input to the driver circuit 32 and the start-up control unit 16. The driver circuit 32 controls the switching device 120 to be in the OFF state while the latch signal latch is input. The start-up control unit 16 does not output the start-up signal startup while the latch signal latch is input. Such a control mechanism enables the switching operation to be stopped in the overload state.

The time reduction unit 46 makes the period of the clock signal clk_olp input to the time detection unit 42 in the power supply test mode shorter than the period of the clock signal clk_olp input to the time detection unit 42 in the normal operating mode, to reduce the overload protection detection delay time. In the present example, a clock signal clk_olp_nor, a clock signal clk_olp_test, and a power supply test signal test_ps are input to the time reduction unit 46.

The period of the clock signal clk_olp_test is shorter than that of the clock signal clk_olp_nor. The time reduction unit 46 outputs the clock signal clk_olp_test as the clock signal clk_olp when transitioning to the power supply test mode due to the power supply test signal test_ps. The time reduction unit 46 outputs the clock signal clk_olp_nor as the clock signal clk_olp when operating in the normal operating mode or the circuit test mode. By shortening the period of the clock signal clk_olp input to the time detection unit 42 in the power supply test mode, the overload protection detection delay time measured by the time detection unit 42 can be reduced.

In the present example, the power supply test signal test_ps is not input to a configuration other than the time reduction unit 46. Therefore, transitioning to the power supply test mode does not affect any parameters or features other than the overload protection detection delay time. This allows the environment in the power supply test mode to be set close to the normal operating mode environment.

The clock generation unit 60 generates each clock signal supplied to the internal circuit of the control chip 100. In the present example, the clock generation unit 60 may generate a clock signal clk_ini, a clock signal clk_xcap, a clock signal clk_olp_nor, and a clock signal clk_olp_test according to the circuit test mode signal test_ic.

The clock generation unit 60 may generate the clock signal clk_olp_test with a constant period regardless of the circuit test mode signal test_ic. The clock generation unit 60 may have the periods of the clock signal clk_ini, the clock signal clk_xcap and the clock signal clk_olp_nor in the circuit test mode be shorter than the period of each clock in the normal operating mode. For example, the period of the clock signal clk_olp_nor when being in the circuit test mode is shorter than the period of the clock signal clk_olp_nor when being in the normal operating mode. This allows shortening the period of the clock signal clk_olp input to the time detection unit 42 in the circuit test mode, and allows reducing the overload protection detection delay time in the circuit test mode. The period of the clock signal clk_olp in the circuit test mode may be set to be the same as, or may be set to be different from the period of the clock signal clk_olp in the power supply test mode.

The clock signal clk_ini is input to the initial setting unit 50. The initial setting unit 50 determines whether or not the initial setting period has elapsed by counting the pulse number of the clock signal clk_ini. By making the period of the clock signal clk_ini in the circuit test mode shorter than the period of the clock signal clk_ini in the normal operating mode, the initial setting period in the circuit test mode can be reduced. On the other hand, the period of the clock signal clk_ini in the power supply test mode is the same as the period of the clock signal clk_ini in the normal operating mode. Therefore, the initial setting period in the power supply test mode is not reduced.

The clock signal clk_xcap is input to the discharge unit 14. The discharge unit 14 determines whether or not the period during which the smoothing capacitor 146 should be discharged has elapsed by counting the pulse number of the clock signal clk_xcap. By making the period of the clock signal clk_xcap in the circuit test mode shorter than the period of the clock signal clk_xcap in the normal operating mode, the discharging period in the circuit test mode can be reduced. On the other hand, the period of the clock signal clk_xcap in the power supply test mode is the same as the period of the clock signal clk_xcap in the normal operating mode. Therefore, the discharging period in the power supply test mode is not reduced. Note that as described above, the discharge unit 14 may be stopped in the circuit test mode, and the discharge unit 14 may be activated in the normal operating mode and the power supply test mode.

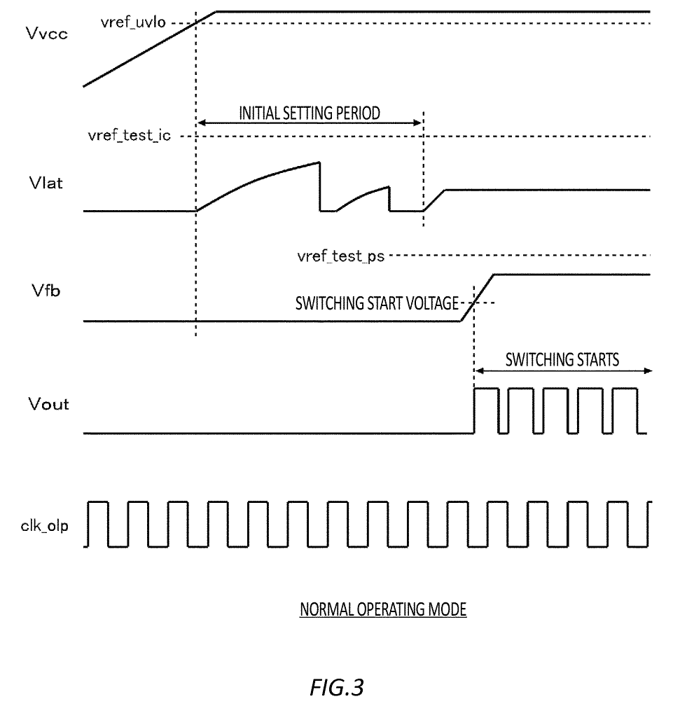

FIG. 3 illustrates an example of time waveforms of each voltage and a clock signal in the normal operating mode. FIG. 3 shows time waveforms at start-up of the switching power supply 300. A reset signal rst in the low-voltage detection unit 12 is released at the point in time when the power voltage Vvcc has become equal to or greater than the release voltage vref_uvlo. At the timing when the reset signal rst has been released, the circuit test mode switching unit 52 determines whether or not the voltage Vlat is equal to or greater than the reference voltage vref_test_ic, and determines whether or not to transition to the circuit test mode. Similarly, at the timing when the reset signal rst has been released, the power supply test mode switching unit 34 determines whether or not the voltage Vfb is equal to or greater than the reference voltage vref_test_ps, and determines whether or not to transition to the power supply test mode. In the example of FIG. 3, since the voltage Vlat is lower than the reference voltage vref_test_ic, and the voltage Vfb is lower than the reference voltage vref_test_ps, the control chip 100 operates in the normal operating mode.

At the timing when the reset signal rst has been released, the initial setting is performed by the initial setting unit 50. Details about the initial setting are described below. When the initial setting ends, if the voltage Vfb becomes equal to or greater than the switching-start voltage, the switching operation of the switching device 120 starts. In the present example, the period of the clock signal clk_olp does not vary before or after the release of the reset signal rst.

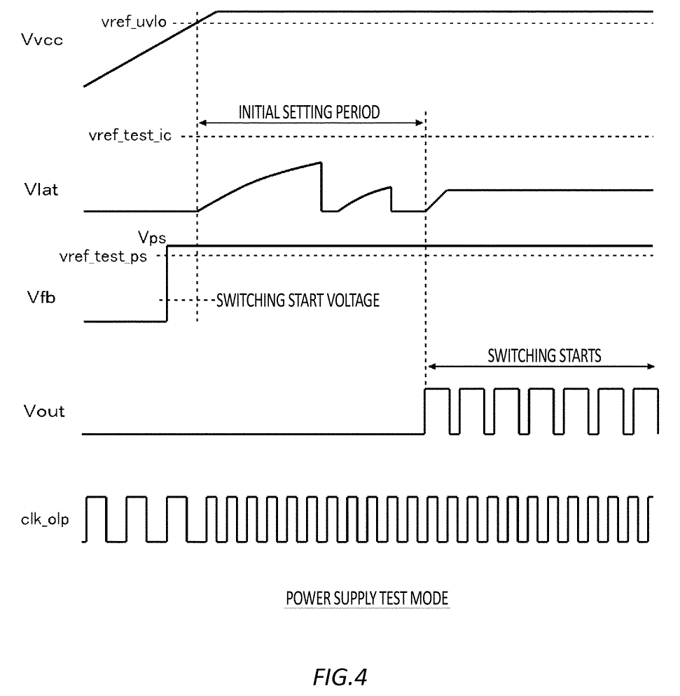

FIG. 4 illustrates an example of time waveforms of each voltage and a clock signal when transitioning to the power supply test mode. In the present example, a voltage Vps of the power supply 188 is applied to the FB terminal before the power voltage Vvcc becomes equal to or greater than the release voltage vref_uvlo. In the present example, at the timing when the reset signal rst has been released, since the voltage Vlat is lower than the reference voltage vref_test_ic, and the voltage Vfb is equal to or greater than the reference voltage vref_test_ps, transition occurs to the power supply test mode.

The power supply test mode is performed without reducing the initial setting period. Also, the period of the clock clk_olp becomes shorter along with the transition to the power supply test mode. This enables reduction of the overload protection detection delay time. In the power supply test mode, when the overload protection detection test has been performed after the switching starts, the operation time itself of the power supply test mode itself can be shortened to use this accelerated clock clk_olp.

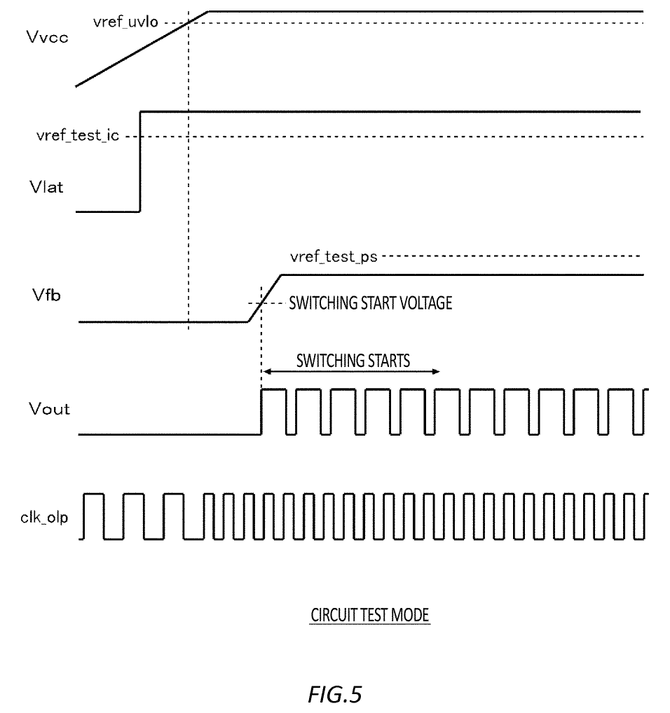

FIG. 5 illustrates an example of time waveforms of each voltage and a clock signal when transitioning to the circuit test mode. In the present example, before the power voltage Vvcc becomes equal to or greater than the release voltage vref_uvlo, a voltage greater than the reference voltage vref_test_ic is applied to the LAT terminal from a testing apparatus or the like. In the present example, at the timing when the reset signal rst has been released, since the voltage Vlat is greater than the reference voltage vref_test_ic, and the voltage Vfb is lower than the reference voltage vref_test_ps, transition occurs to the circuit test mode.

In the circuit test mode, the period of the clock signal clk_ini for measuring the initial setting period becomes shorter. Therefore, the initial setting period becomes shorter or approximately 0. In FIG. 5, the initial setting period is omitted. Also, the period of the clock clk_olp becomes shorter along with the transition to the circuit test mode. This enables reduction of the overload protection detection delay time. In this manner, in the circuit test mode, after the switching starts, when performing the overload protection detection test, this accelerated clock clk_olp is used. Furthermore, the initial setting period also becomes shorter. Accordingly, the operation time of the circuit test mode itself can be shorter when compared to the power supply test mode.

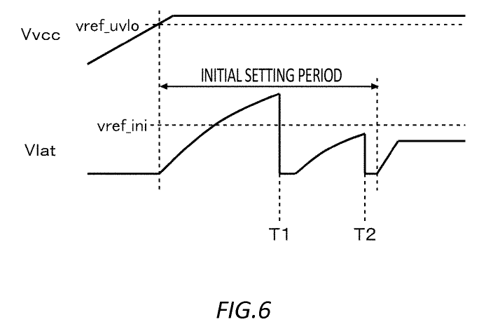

FIG. 6 illustrates exemplary operations during the initial setting period. During the initial setting period, the control chip 100 outputs a constant current from the LAT terminal. The capacitor 139 is charged by the constant current, and the voltage Vlat gradually increases.

At a timing T1 when a preset period of time has elapsed after the initial setting period starts, the initial setting unit 50 compares the voltage Vlat and the reference voltage vref_ini, and outputs the initial setting signal ini_sel 1 according to the comparison result. The initial setting signal ini_sel 1 is a signal that selects a reference value vref_olp for detecting overload in the overload detection unit 40. For example, the initial setting unit 50 causes the reference value vref_olp 1 to be selected when the voltage Vlat is equal to or greater than the reference voltage vref_ini, and causes the reference value vref_olp 2 to be selected when the voltage Vlat is less than the reference voltage vref_ini. The voltage Vlat can be set due to the resistance value of the resistor 138 and the capacity of the capacitor 139, and can be set as the reference value vref_olp at the timing T1. The initial setting unit 50 discharges the capacitor 139 to set the voltage Vlat as the reference potential at the timing T1.

In the present example, also at a timing T2 after the timing T1, the initial setting unit 50 compares the voltage Vlat and the reference voltage vref_ini and outputs the initial setting signal ini_sel 2 according to the comparison result. The initial setting signal ini_sel 2 is a signal that selects to enable or disable the X-CAP discharge feature in the discharge unit 14. For example, the initial setting unit 50 enables the X-CAP discharge feature when the voltage Vlat is equal to or greater than the reference voltage vref_ini, and disables the X-CAP discharge feature when the voltage Vlat is less than the reference voltage vref_ini. Due to the resistance value of the resistor 138 and the capacity of the capacitor 139, the voltage Vlat can be set at the timing T2, and the X-CAP discharge feature can be set to be valid or invalid.

As described above, in the circuit test mode, the initial setting period is reduced, or the initial setting can not be performed as it is omitted. Therefore, when willing to test the power supply circuit 230 in the circuit test mode, the test of the power supply circuit 230 is performed in environment greatly different from the normal operating mode. Therefore, in the circuit test mode, the power supply circuit 230 can be tested with high precision. Meanwhile, by providing the power supply test mode, the test of the power supply circuit 230 can be performed in environment close to the normal operating mode.

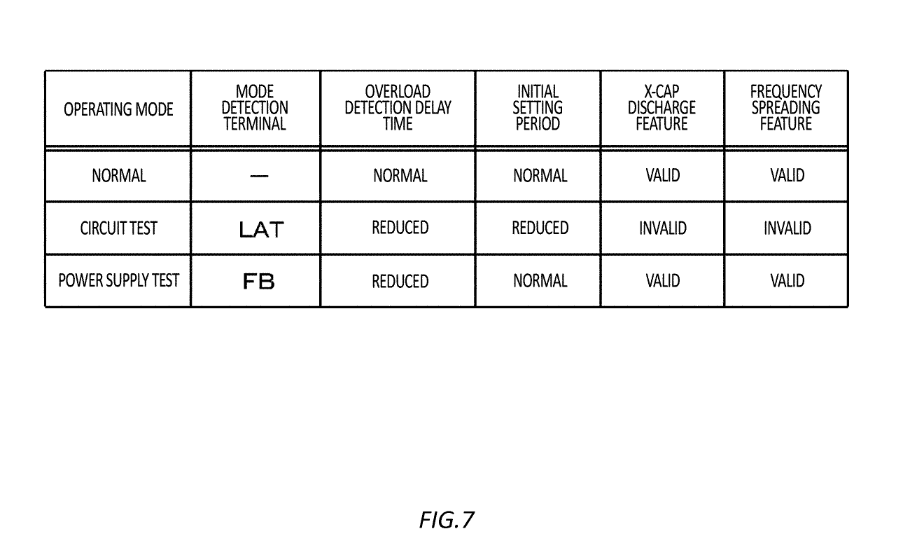

FIG. 7 schematically illustrates the normal operating mode, the circuit test mode and the power supply test mode. As described above, the control chip 100 transitions to the circuit test mode according to whether or not the voltage Vlat at the LAT terminal is equal to or greater than the reference voltage vref_test_ic. Also, the control chip 100 transitions to the power supply test mode according to whether or not the voltage Vfb at the FB terminal is equal to or greater than the reference voltage vref_test_ps.

In the normal operating mode, the X-CAP discharge feature and the frequency spreading feature are set to be in the valid state without reducing the overload detection delay time and the initial setting time. In the circuit test mode, the overload detection delay time and the initial setting time are reduced, and the X-CAP discharge feature and the frequency spreading feature are set to be in the invalid state. In the power supply test mode, the overload detection delay time is reduced, the initial setting time is reduced, and the X-CAP discharge feature and the frequency spreading feature are set to be in the valid state.

In the present example, the control chip 100 has at least three operating modes, including a circuit test mode for testing the control chip 100, a power supply test mode for testing the power supply circuit 230, and a normal operating mode. As shown in FIG. 7, the control chip 100 operates closer to the normal operating mode in the power supply test mode than in the circuit test mode. For example, with each setting of time and settings of enabling and disabling each feature shown in FIG. 7, the power supply test mode has more items identical to the normal operating mode than the circuit test mode. In this manner, by providing the operating mode, the test of the control chip 100 and the test of the power supply circuit 230 can each be performed with high precision.

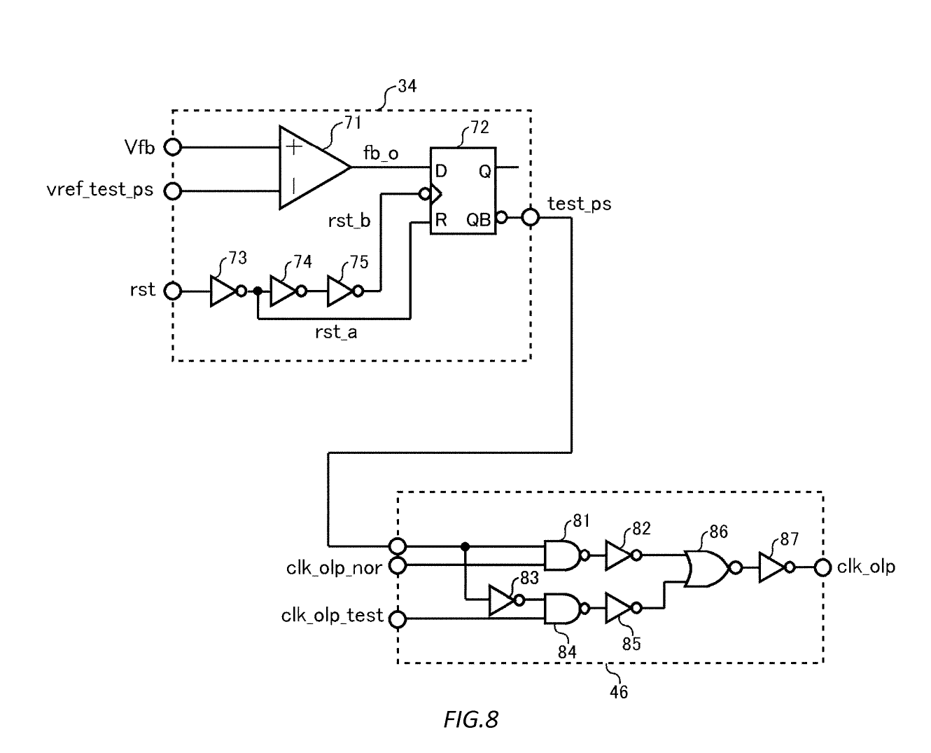

FIG. 8 illustrates configuration examples of the power supply test mode switching unit 34 and the time reduction unit 46. In the present example, the power supply test mode switching unit 34 has a comparator circuit 71, a flip-flop 72 and a plurality of inverters 73, 74, 75. The comparator circuit 71 outputs a comparison signal fv_o obtained by comparing the voltage Vfb and the reference voltage vref_test_ps. For example, the comparison signal fb_o is a signal that becomes a logic H when the voltage Vfb is equal to or greater than the reference voltage vref_test_ps, and becomes a logic L when the voltage Vfb is less than the reference voltage vref_test_ps.

The plurality of inverters 73, 74, 75 are connected in series. A reset signal rst is input to the inverter 73 at a first stage. For example, the reset signal rst is a signal that becomes the logic H when the power voltage Vvcc is less than the release voltage vref_uvlo, and becomes the logic L when the power voltage Vvcc is equal to or greater than the release voltage vref_uvlo.

A comparison signal fb_o is input to an input terminal D of the flip-flop 72. The reset signal rst is delayed by the inverters 73, 74, 75, and the inverted signal rst_b is input to an inverted clock terminal of the flip-flop 72. The flip-flop 72 captures to output the comparison signal fb_o according to the signal rst_b. A signal rst_a obtained by inverting the reset signal rst is input to a reset terminal R of the flip-flop 72. A power supply test signal test_ps is output from an inverted output terminal QB of the flip-flop 72. For example, the power supply test signal test_ps is a signal that indicates the logic L when transitioning to the power supply test mode, and indicates the logic H when not transitioning.

The time reduction unit 46 selects either the clock signal clk_olp_nor or the clock signal clk_olp_ps to output the clock signal clk_olp according to the power supply test signal test_ps. In the present example, the time reduction unit 46 has a plurality of logical product circuits 81, 84, a plurality of inverters 82, 83, 85, 87 and a logical disjunction circuit 86.

The logical product circuit 81 inverts to output a logical conjunction of the power supply test signal test_ps and the clock signal clk_olp_nor. That is, the logical product circuit 81 outputs a signal masked to be the logic H when being in the power supply test mode (the power supply test signal test_ps is the logic L), and passes the clock signal clk_olp_nor when not being in the power supply test mode.

The logical product circuit 84 inverts to output a logical conjunction of the power supply test signal test_ps inverted by the inverter 83 and the clock signal clk_olp_test. That is, the logical product circuit 81 outputs a signal masked to be the logic H when in the power supply test mode, and passes the clock signal clk_olp_nor when not in the power supply test mode.

The inverter 82 inverts the output of the logical product circuit 81. The inverter 85 inverts the output of the logical product circuit 84. The logical disjunction circuit 86 inverts to output a logical disjunction of the output of the inverter 82 and the output of the inverter 85. In this manner, the logical disjunction circuit 86 passes either one of the clock signal clk_olp_nor or the clock signal clk_olp_test. The inverter 87 inverts the output of the logical disjunction circuit 86 to output the clock signal clk_olp.

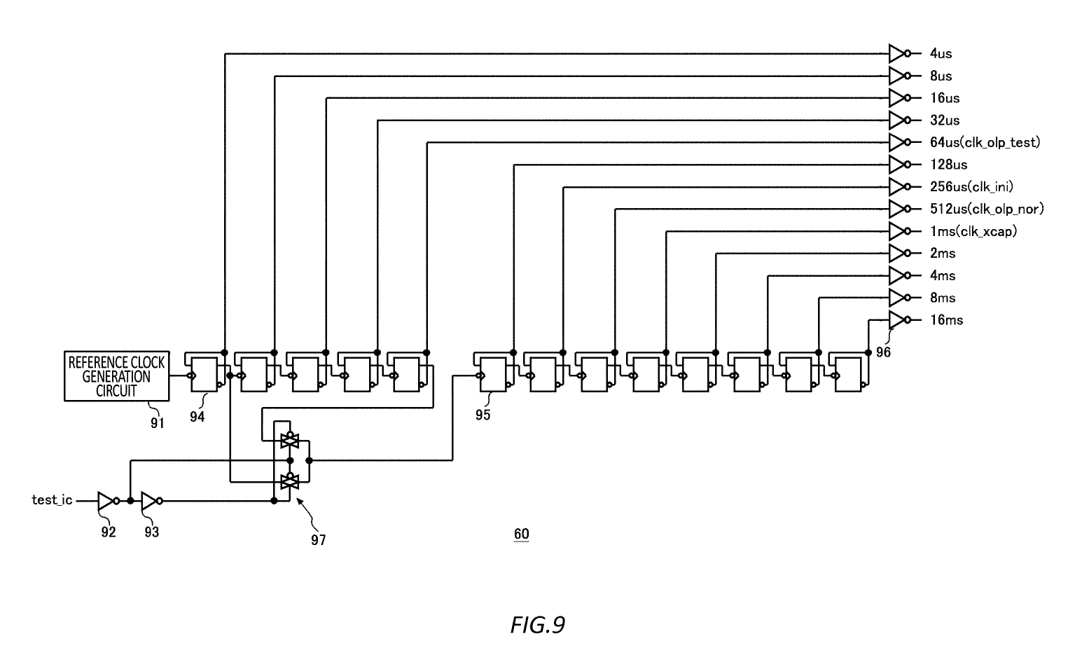

FIG. 9 illustrates a configuration example of the clock generation unit 60. In the present example, the clock generation unit 60 has a reference clock generation circuit 91, an inverter 92, an inverter 93, a period switching unit 97, a plurality of flip-flops 94, a plurality of flip-flops 95, and a plurality of inverters 96. The reference clock generation circuit 91 generates a reference clock with a predetermined period. In the present example, the period of the reference clock is 2 μs, but it is not limited thereto. The plurality of inverters 96 invert the output of each of the flip-flops 94 and the flip-flops 95.

In the plurality of flip-flops 94, the output of the preceding flip-flop 94 is input to the subsequent flip-flop 94 as a clock. Also, the inverted output of each flip-flop 94 is connected to its input terminal. Through such connections, each flip-flop 94 outputs a signal, as a clock, with a period doubling that of the input clock signal. A reference clock is input to the flip-flop 94 at the first stage. Through such connections, the plurality of flip-flops 94 can generate a plurality of clock signals with periods increasing by doubling each time, such as 4μs, 8μs, ..., 64μs.

The inverter 92 inverts to output the circuit test mode signal test_ic. The inverter 93 further inverts to output the output of the inverter 92. The period switching unit 97 accepts a high-speed clock signal (period of 4 μs in the present example) output by the flip-flop 94 at the first stage, and a low-speed clock signal (period of 64 μs in the present example) output by the flip-flop 94 at a later stage (for example, the last stage). The period switching unit 97 selects either the high-speed clock signal or the low-speed clock signal to input the flip-flop 95 at the first stage in the plurality of flip-flops 95 according to the circuit test mode signal test_ic. In the present example, the period switching unit 97 selects the high-speed clock signal when in the circuit test mode, and selects the low-speed clock signal when not in the circuit test mode.

The plurality of flip-flops 95 are connected similarly to the plurality of flip-flops 94. That is, each flip-flop 95 outputs a clock signal with a period doubling that of the preceding flip-flop 95. As shown in FIG. 9, when not in the circuit test mode, the plurality of flip-flops 95 output clock signals with periods of 128 μs, 256 μs,…,16 ms. On the other hand, when being in the circuit test mode, the plurality of flip-flops 95 generate clock signals with shorter periods, such as 8 μs, 16 μs, …

In the present example, the clock generation unit 60 selects a signal output by any flip-flop 94 to output it as a clock signal clk_olp_test to measure the overload protection detection delay time in the power supply test mode. Also, the clock generation unit 60 selects signals as the clock signal clk_ini, the clock signal clk_olp_nor and the clock signal clk_xcap from the output of the plurality of flip-flops 95, respectively. Since the period of the signal output by the flip-flop 95 varies according to the circuit test mode signal test_ic, the periods of the clock signal clk_ini, the clock signal clk_olp_nor and the clock signal clk_xcap can be changed according to whether or not they are in the circuit test mode.

While the present invention has been described by way of the embodiments, the technical scope of the present invention is not limited to the above-described embodiments. It is apparent to persons skilled in the art that various alterations or improvements can be made to the above-described embodiments. It is also apparent from the description of the claims that the embodiments to which such modifications or improvements are made may be included in the technical scope of the present invention.

What is claimed is:

1. A control chip that is supplied with input power from a power supply circuit, and controls a switching device of a switching power supply which supplies output power to a load, comprising:
at least two operating modes, including a power supply test mode for testing the power supply circuit and a normal operating mode;
a feedback terminal to which a feedback signal is input according to an output voltage applied to the load; and
a power supply test mode switching unit that switches between the power supply test mode and the normal operating mode according to a switch signal input to the feedback terminal.

2. The control chip according to claim 1, wherein:
the control chip has a power supply terminal to which a power voltage for driving the control chip is applied; and
the power supply test mode switching unit switches between the power supply test mode and the normal operating mode according to the power voltage applied to the power supply terminal and the switch signal.

3. The control chip according to claim 2, further comprising
a low-voltage detection unit that stops switching operation in the switching device when the power voltage is lower than a set release voltage,
wherein the power supply test mode switching unit activates the control chip in the power supply test mode when the switch signal is input, in a state where the power voltage is lower than the release voltage.

4. The control chip according to claim 1, wherein the control chip in the power supply test mode reduces overload protection detection delay time when compared to the normal operating mode.

5. The control chip according to claim 2, wherein the control chip in the power supply test mode reduces overload protection detection delay time when compared to the normal operating mode.

6. The control chip according to claim 3, wherein the control chip in the power supply test mode reduces overload protection detection delay time when compared to the normal operating mode.

7. The control chip according to claim 4, wherein the control chip has:
a time detection unit that senses that the overload protection detection delay time has elapsed based on an input clock signal; and
a time reduction unit that makes a period of the clock signal input to the time detection unit in the power supply test mode shorter than a period of the clock signal input to the time detection unit in the normal operating mode, to reduce the overload protection detection delay time.

8. The control chip according to claim 5, wherein the control chip has:
a time detection unit that senses that the overload protection detection delay time has elapsed based on an input clock signal; and
a time reduction unit that makes a period of the clock signal input to the time detection unit in the power supply test mode shorter than a period of the clock signal input to the time detection unit in the normal operating mode, to reduce the overload protection detection delay time.

9. The control chip according to claim 6, wherein the control chip has:
a time detection unit that senses that the overload protection detection delay time has elapsed based on an input clock signal; and
a time reduction unit that makes a period of the clock signal input to the time detection unit in the power supply test mode shorter than a period of the clock signal input to the time detection unit in the normal operating mode, to reduce the overload protection detection delay time.

10. The control chip according to claim 4, further has
a circuit test mode, as one of the operating modes, for testing the control chip,
wherein the control chip operates closer to the normal operating mode in the power supply test mode than in the circuit test mode.

11. The control chip according to claim 10, wherein the control chip reduces the overload protection detection delay time and reduces an initial setting period when compared to the normal operating mode in the circuit test mode.

12. The control chip according to claim 10, wherein:
the power supply circuit has:
an AC power supply; and
a smoothing capacitor provided between a positive-side output terminal and a negative-side output terminal of the AC power supply, and
the control chip has:
a power supply detection terminal connected to the power supply circuit; and
a discharge unit to cause the smoothing capacitor to be discharged when a voltage input to the power supply detection terminal is a DC voltage, and
stops the discharge unit in the circuit test mode, and activates the discharge unit in the normal operating mode and the power supply test mode.

13. The control chip according to claim 10, further comprising
a frequency spreading unit that varies a switching frequency of the switching device,
wherein the frequency spreading unit is stopped in the circuit test mode, and the frequency spreading unit is activated in the normal operating mode and the power supply test mode.

14. A control chip that is supplied with input power from a power supply circuit and controls a switching device of a switching power supply which supplies output power to a load,
having at least three operating modes, including a circuit test mode for testing the control chip, a power supply test mode for testing the power supply circuit, and a normal operating mode.

15. A switching power supply that supplies output power to a load based on input power, comprising:
a power supply circuit that generates the input power;
a switching device; and
the control chip according to claim 1, which controls the switching device.

16. A switching power supply that supplies output power to a load based on input power, comprising:
a power supply circuit that generates the input power;
a switching device; and
the control chip according to claim 14, which controls the switching device.

17. A switching power supply that supplies output power to a load based on input power, comprising:
a power supply circuit that generates the input power;
a switching device; and
a control chip that controls the switching device,
wherein the control chip includes a feedback terminal to which a feedback signal is input according to an output voltage applied to the load; and
the switching power supply includes a switching signal generation unit that inputs a switch signal with a set voltage to the feedback terminal when the output voltage is lower than a predetermined threshold voltage, and stops input of the switch signal toward the feedback terminal when the output voltage is equal to or greater than the threshold voltage.

18. The switching power supply according to claim 17, wherein:
the control chip
has at least two operating modes, including a power supply test mode for testing the power supply circuit and a normal operating mode; and
switches between the power supply test mode and the normal operating mode according to a switch signal input to the feedback terminal.

19. The switching power supply according to claim 18, wherein:
the control chip
includes a power supply terminal to which a power voltage for driving the control chip is applied; and
switches between the power supply test mode and the normal operating mode according to the power voltage applied to the power supply terminal and the switch signal.

20. The switching power supply according to claim 19, wherein
the control chip
includes a low-voltage detection unit that stops switching operation in the switching device when the power voltage is lower than a set release voltage, and
transitions to the power supply test mode when the switch signal is input, in a state where the power voltage is lower than the release voltage.
